(19) United States
(12) Patent Application Publication
(10) Pub. No.: US 2008/0047160 A1
(43) Pub. Date: Feb. 28, 2008

(54) Method and machine for the sintering and/or drying of powder materials using infrared radiation

(76) Inventor: Joan IGLESIAS VIVES, Santa Eulalia de Roncana (ES)

Correspondence Address: Ralph A. Dowell of DOWELL & DOWELL P.C., 2111 Eisenhower Ave, Suite 406, Alexandria, VA, 22314, US

(21) Appl. No.: 11/630,039

(22) PCT Filed: Sep. 21, 2004
(86) PCT No.: PCT/ES04/00412

§ 371 Date: Jan. 16, 2007

(51) Int. Cl. F26B 3/34

(52) U.S. Cl. 34/266

(57) ABSTRACT

The invention relates to a method and a device, as well as the variants thereof, which operates continuously or discontinuously for the agglomeration and/or drying of powder materials using selective infrared irradiation on a surface which is continually supplied with renewed powder, with or without the spraying of liquids. The process can be performed in sealed conditions or open the atmosphere, with or without the recovery of volatile components.

Specifically, the invention refers to a machine that is specially designed for the agglomeration and/or drying of powdered materials, through the application of infrared radiation by a process that will be explained in more detail further on. Other processes exist in the market that are used to achieve the same result, such as wet and dry compacting, pelletization, spray drying, wet extrusion and wet granulation, which are considered as State of the Art. Pelletization is a process that is based on forcing a powder to go through an orifice, thus obtaining a symmetrical granule in the form of a cylinder. This process may be carried out either wet or dry format and is restricted to granules with a cylinder diameter of at least few millimetres. The dry version lacks versatility, given that each product will require a different matrix.

Spray drying is a process that requires that the solid is dispersed and/or dissolved in a liquid to later be pulverized and exposed to a current of dry air to remove the water. The obtained granules have a particularly small particle size of 20 to 300 microns, and the energy cost for this type of process is high.

Extrusion is a procedure, which involves passing a material of pasty consistency (it could either be a melt or a solid/liquid blend) through orifices using a turning screw. It then proceeds to be sliced, cooled and/or dried and from this we obtain the granules.

Wet granulation is another known procedure, which involves pulverizing a powdered solid with a moving liquid to give granules that are later dried.

Other previous literature includes the German patent DE-3446424A1 and U.S. Pat. No. 5,560,122.

The patent DE-3446424A1 describes an IR radiation application to dry solid materials, where IR emitters are located inside a rotating drum with cooled walls, which permits the drying of solids via a batch process. This invention presents certain disadvantages, which are resolved using this new technique. The new technique described below presents the following comparative advantages:
It is applicable in both batch and continuous drying processes, not just batch.
The vessel walls do not become heated due to the fact that the IR radiation is selectively applied to the product. In the previous system, both the walls and the product that sticks to the walls reach higher temperatures than the main bulk of product to be dried. This is because the walls are exposed directly to IR radiation and may risk the product quality, as usually happens due to excessive temperature.
The present invention has a system for breaking up the lumps that are often formed, which the previous patent does not possess.
The present invention avoids the surface deposits of product inside the dryer, which can lead to the deterioration of the product due to excessive and prolonged heat exposure.
The dynamic of the movement of the dried bed minimizes the creation of dust clouds, unlike the previously mentioned patent, where the generated dust tends to cover the IR radiation source. This may also lead to product deterioration.

The U.S. Pat. No. 5,560,122 is also a batch process apparatus, which is used for the blending, wet granulation and post-drying of pharmaceutical products through four different methods. The drying methods include contact, IR radiation via an external window, the injection of hot air and vacuum. This second invention also presents certain disadvantages, which are resolved by the new technique. The comparative advantages of the new technique are the following:
It is applicable in both batch and continuous drying processes, not just in batch.
Only one single source of energy (IR radiation) is used, instead of four sources: contact, IR radiation via an external window, the injection of hot air and vacuum.
Being direct the transmission of the IR, its efficiency is much higher and it reaches a much wider surface area, unlike the patent previously mentioned, where the imposition of a glass window limits the surface exposure. This window not only causes a loss of radiation intensity but also requires the window to be cooled due to the absorbed radiation by the glass and the over-heated product that sticks to the inner side of the window. This adhered product may deteriorate and therefore it could contaminate the agglomerated material if it comes loose.

The advantages of this new procedure when compared to the current techniques, such as wet and dry compacting, are that it does not require post-treatments like the granulation (size reduction) of the compacted product sheets, and neither drying. The particles obtained from the new technique can be much smaller, with spheroid shape, and less content of dust and more attrition resistant, all of which makes the material more free-flowing.

Furthermore, other advantages should be taken into account, such as the energetic savings that come from not having to evaporate so much water and from the fact that the volume of the required equipment is much less. With respect to extrusion, where the products are fused, the new technique offers significant advantages: critical steps such as passing through the orifice and product slicing can be avoided, the particle size is smaller, and the particle spherical shape. These improvements are basically in final application, storage and transportation of the final product.

The energetic efficiency of the new procedure is not significantly influenced by the shearing stress of the extrusion screw. Thus, due to it operates with very minor shear stress the deterioration of the product is very low. The ease of processing products of low bulk density does not reduce production. The presence of volatiles is not problematic given that gases do not end up trapped inside the barrel, as happens for example with extrusion. Thus degasification is not necessary. Furthermore the temperature, which must be reached by the product to become granulated, is less. This not only increases energetic efficiency but also causes less damage to thermally unstable products. The new technique leads to greater process control and far less energetic cost.

On the other hand the described technology presents a notable advantage, compared to the wet granulation process, when melted components are present, as they can act as an agglomerating agent thereby rendering the later steps of pulverization and drying unnecessary. In the case of the liquid pulverization procedure, which is also described herein, the system has the advantage of combining both the wet granulation and the drying into the same equipment.

The technical sectors to which the new invention is directed include among others the chemical, pharmaceutical, agrochemical, food, iron/steel, plastics, ceramic, rubber, fertilizer, detergent, powder coatings, pigment and waste treatment industries.

The objective of this invention is to improve the material handling and flow of the product, avoid the risk of lumps formation, facilitate the dosing, reduce the risk of dust cloud explosions, prepare the product for direct compression, reduce user exposure and any other associated product risks.

With the new method, several functions can be carried out in just one unified unit, whereas up until now each of these functions have required different machines. This can be explained via three application fields, each titled by way of example below:
The first field is for products that need to be dried with solvent recovery. The new technique allows for the production of dry, powder or granular product with the aforementioned machine; whereas conventionally one would require various machines disposed in series: a dryer with solvent recovery, a cooler of powder dried product, an intermediary silo for the powder product, and a sieve for fine-particle recovery.
The second field is to obtain a granular product comprised of several components in powder form with total or partial product melting. The new technique permits the production of granular material composed of various powder components in one single equipment; this considering that what is usually required is a mixing and fusion machine (extruder) and a water-cooled heat cutter positioned after it, followed by an air dryer to remove the water and finally a sieve to separate the fine particles from the coarse ones.
The third field deals with obtaining a granulated product to be directly compressed into tablets, starting from filter press cake. Using a single unit the new technique allows for the production of granular product, which is known in the pharmaceutical industry as “Direct Compression” (DC) quality. Usually this would require several machines in series, such as a dryer with solvent recovery, a cooler of powder product, a intermediary silo for the powder product, a compactor, a granulator (particle size decrease) and a sieving set.

The invention procedure is based on the application of infrared radiation on moving powder form material with the aim of producing particles of agglomerated material. Depending on the material's composition, the absorption of radiation produces different effects: if the blend includes compounds with low melting points, a partial fusion occurs; and if the mix includes volatile compounds, the material is dried. In general, both phenomena may occur. Each of the effects is used to create agglomerate particles of a controlled size.

The material to be processed can be wet, as in the case of the filter press cake, or dry with low or no volatile substances content. The material may also be composed of a single compound or several ones. In the case of several compounds, the process simultaneously performs a homogenous blend.

If the solvent medium is a liquid, this can be easily recovered from the generated vapours by condensation, first having the machine suitably sealed. If on the other hand the products are dry, the agglomeration with the aforementioned machine can follow two different routes:

The first involves the partial melting of some of the starting material components, which will in turn act as an agglutinant.

The second way is to spray the material with a liquid which dissolves one or more components of the initial material, or which contains components that act as agglutinants themselves. If the liquid is volatile, it is evaporated by a further application of IR radiation.

The procedure can also be adapted to either batch or continuous processes. In both cases, the material flow inside the equipment can follow a Plug-Flow reactor (PFR) model or the Completely Stirred Tank Reactor (CSTR) model or any intermediate material flow between these two ideal models.

The source of IR radiation should ideally be a ceramic or metallic surface, which emits radiation via the Plank effect with superficial temperatures that oscillate between 200° C. and 3000° C. The source of this radiation energy is usually electric, although other alternatives such as direct combustion of liquid or gaseous fuels may be applied in those processes where said cheaper energy sources are required.

Further details and features of the method and machine for the agglomeration and/or drying of powder materials using infrared radiation will be clearer from the detailed description of preferred embodiments, which will be given hereinbelow by way of non limitative examples, with reference to the drawings herein accompanied, in which:

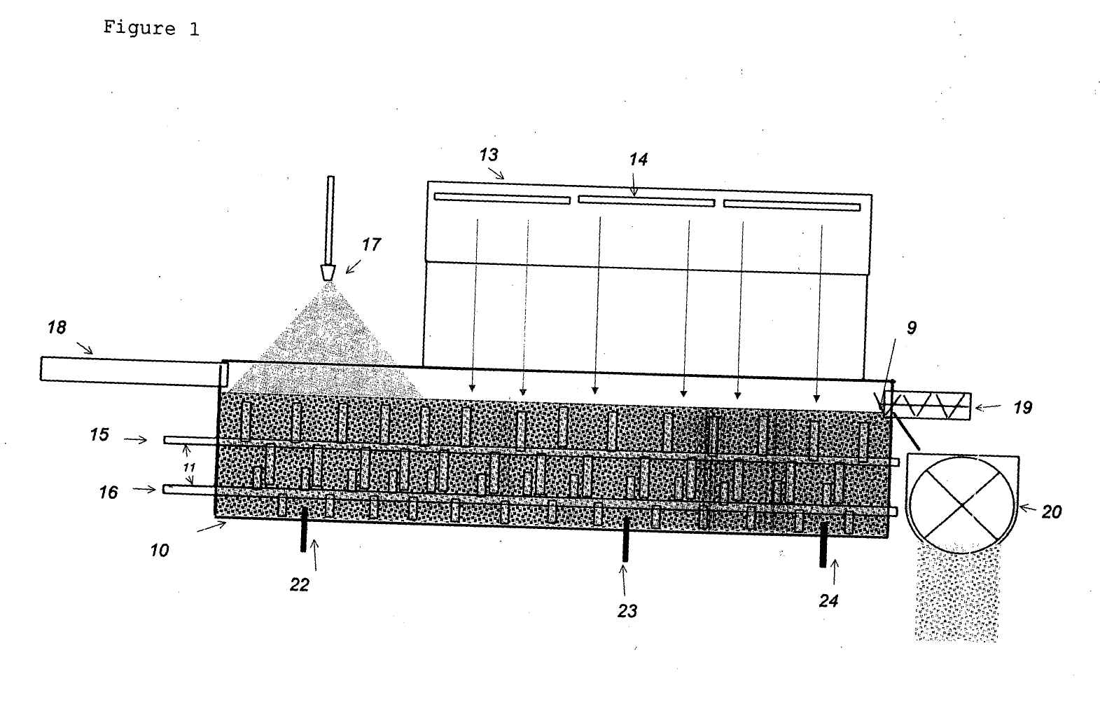

FIG. 1 is a front elevated schematic view of the machine according to the invention in a non-airtight version, in which each of the different parts can be seen. The machine is conceived for working in continuous with pulverization provided with a crusher axis.

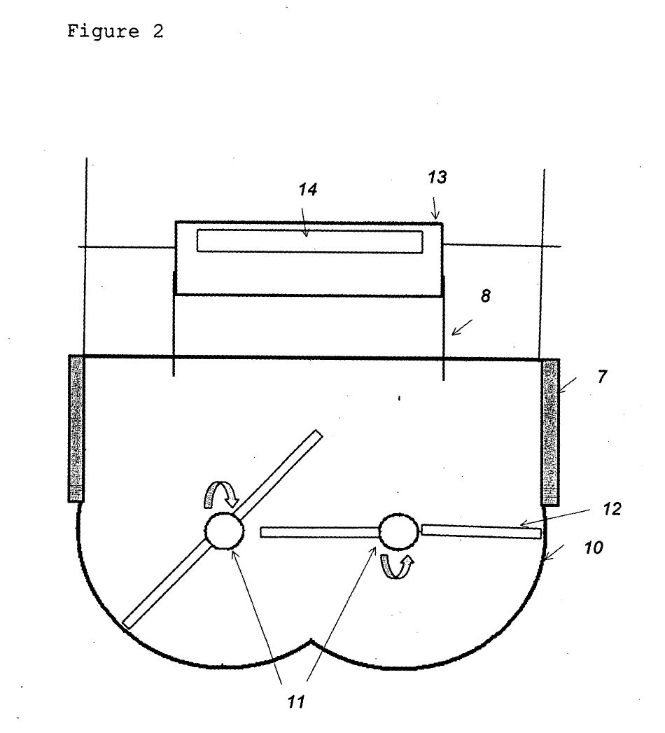

FIG. 2 is an elevated cross-sectional schematic view of the machine according to the invention in a non-airtight version, to be operated in continuous form with only two mixing shafts and without a crusher shaft.

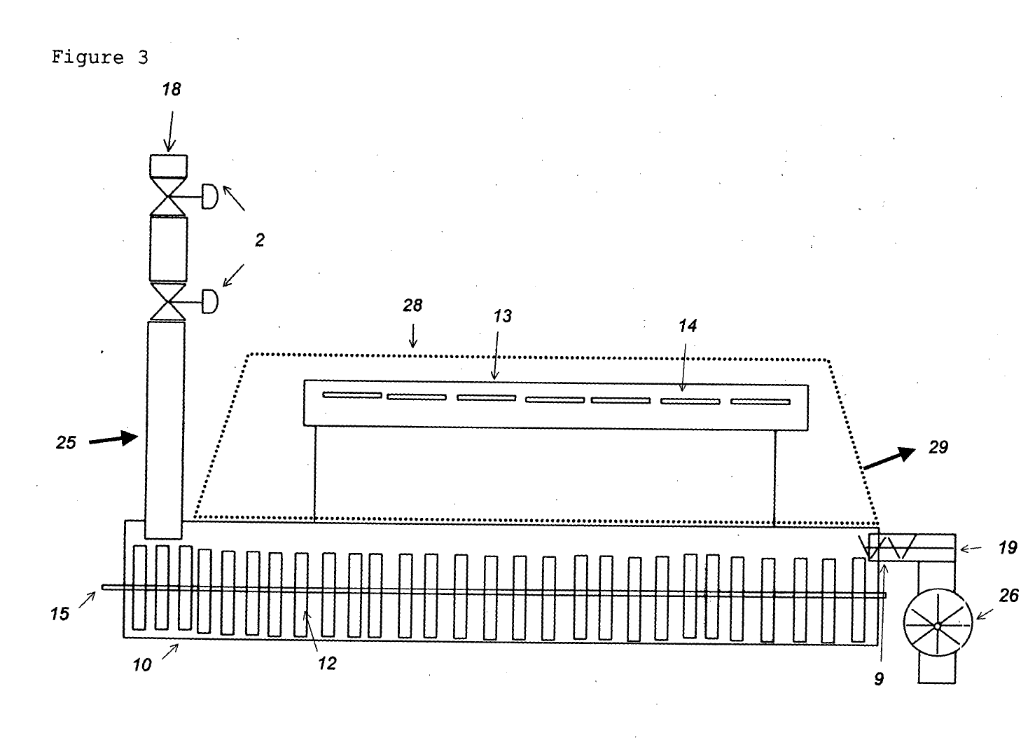

FIG. 3 is a front elevated schematic view of the machine according to the invention in an airtight version, in which each of the different parts can be seen. As such it can operate in continuous form but without a crusher shaft.

There follows a detailed and numerated index to define the different parts in the embodiments of the invention as shown in the figures annexes: (2) set of valves, (10) vessel, (11) shafts, (12) blades, (13) focusing screen, (14) IR source, (15, 16) mixing elements, (17) spray, (18) product, (19) screw, (20) granulator, (22, 23, 24) sensors, (25) vent, (26) rotary valve, (28) cover and (29) vacuum outtake.

The continuous operation mode is a preferred patent option.

Operation in continuous mode A:

The machine is continuously fed with the different components of the formula to be dried and/or granulated (18), this is done in such a way as to control their mass input flow into the vessel (10). The mass will be stirred with a rotating shaft (11) with blades (12). It is provided multiple stirring shafts (11), but al least two. These two stirring shafts are designated in the drawings as references (15) and (16).

A focusing screen (13) containing the IR source (14) is located above the vessel (10). The power of this infrared radiation source (14) is regulated by measuring the source temperature or, in case of direct combustion, controlling the flows of fuel and air.

The stirring elements (15) and (16), which are comprised of rotating shafts (11) with blades (12), ensure a rapid renewal of the product exposed to the surface of the vessel, which contributes to a higher homogeneity of the drying and/or granulating process.

It exists two different type of stirring elements (15 and 16), which revolution velocities can be regulated independently.

The upper stirring element (15) rotates at a lower velocity and its basic utility is to renew the product located on the upper surface of the mass and mix it more evenly with the product located further down in the mass.

The main purpose of the lower stirring element (16), whose presence is optional, is to break up those lumps that exceed a certain size using its greater rotating velocity.

The shafts of the stirring elements (15 and 16) can be extracted in order to facilitate cleaning tasks and product changes. These shafts (11) are designed is such a way as to allow blades (12) of varying their length, width, thickness and inclination (of the angle with respect to the rotating axis), in order to adapt to the desired properties of the final product. These characteristics determine the flow dynamics of the product inside the machine.

These variations in the length, width, thickness and inclination of the blades (12) are achieved by either substituting them with other blades of a different size/shape, or indeed by using blades specifically designed to allow a certain degree of adjustment of the aforementioned parameters.

The length and dimensions of the blades (12) allow a self-cleaning effect, given that the blades (12) of one shaft (11) intersect with the blades (12) of the adjacent shafts (11). The tolerance (gap) between adjacent crossing blades can be adjusted by means of changing and/or modifying the blades (12). The potential deposits of product on the outer surface of the shafts (11) are removed continuously by the end point of the blades of the adjacent shaft; see FIG. 2.

The blades (12) are usually inclined with respect to the advance of the rotation direction so that they also produce an auto-clean effect. The inclination of the blade (12), with respect to the turning shaft (11) for a given direction of turn, controls the axial direction in which the product advances. This circumstance is used to regulate how the product advances and can also be used to improve the axial mixing of the product by combining different advance/hold back properties of adjacent blades (12) of the same shaft (11), enhancing thus the mixing effect in axial direction. In this way a homogenous distribution of the product can be achieved in surface, both laterally and axially; said homogeneity is recommendable when opting for a batch process. The two shafts (11) should preferably rotate in opposite directions to maximize the blending.

In order to avoid deposits of the product on the inner surface and/or dead zones, the tolerance (space) between the outer points of the blades (12) and the inner surface of the vessel (10) is minimum. This space can be regulated by means of changing the length of the blade (12). The maximum length value is based on the criteria of approaching the gap size to the desired average particle size. If this value is lower than the standard mechanical design permits, the value will adjust to the one that is recommended in this design.

If the addition of a liquid via a spray (17) is chosen, the flow is adjustable according to the quantities required. This function can be applied before, during or after the IR radiation. The pulverization may be air-assisted and should operate preferably with droplets of low average size (1-200 microns). The quantity of liquid added can vary between 3 and 40% of the weight of the final granulated/dried product.

The agglutinating material can be either a liquid or a melted solid. The liquid can contain dissolved solids, dispersed solids or other dispersed non-miscible liquids.

The continuous extraction of the final product is achieved by overflow when it exceeds the level at the discharge point (9), which is located as far as possible from the feeding point. The height of said discharge level is adjustable. In the case of heavy lumping, the product may be forcibly extracted via a screw (19) with adjustable velocity.

Once the product is discharged, the maximum particle size of the product can be guaranteed by installing a granulator (20), which continuously will crumble the coarse particles: it will force the product through a metal mesh whose aperture size equals the maximum desired particle size.

The granulator (20) installation is optional, given that in most applications the quality of the granule obtained from the machine regarding the particle size is already satisfactory.

If the final product has not to contain particles below a certain size (fines), a sieve (not included in figures) may be placed afterwards, and the fines recovered here can be continuously recycled back into the feed of the process.

The product usually requires cooling before it is packaged and room-temperature air is preferably applied while the product is being transported by vibration, by screw or by fluidised bed. The cooling phase can be carried out immediately after discharge and/or before the granulation/sieving step, depending on the nature of the product.

Both the vessel (10) and the screen (13) are externally covered with thermal insulation material to minimize energy loss and also to avoid the accidental burning of the personnel who are running the machine.

The focusing screen (13) is designed to have an adjustable height in relation to the upper surface of the vessel (10). This allows one to vary the distance between the emitting elements and the product surface between 3 cm. minimum and 40 cm. maximum.

To achieve good final product uniformity, it is important that local overheating above working temperature does not occur in any part of the vessel (10). This is obtained thanks to a combination of the following elements:
a) The internal surface of the vessel (10) is highly reflective to IR radiation and has a metal mirror-finish. The coating includes aluminium, nickel, silver, zinc, etc. This finish also reduces the adherence of product and facilitates cleaning.
b) The area irradiated does not cover the entire upper surface of the product exposed to the air, so the incidental radiation that comes from the source is practically negligible in strip form area surrounding the internal perimeter of the vessel, see FIG. 2.
c) The use of thin disposable reflective sheets of metal (8) placed at the edge of the focusing screen (13) to minimize the radiation likely to reach the wall of the 30 vessel (10), see FIG. 2.
d) Refrigeration of the fraction of the vessel wall (7) directly exposed to radiation, see FIG. 2.

The use of one or more of these elements will depend on the inherent requirements of the desired product.

The correct parameters to achieve a suitable granulation and/or drying are determined by previous testing, which allow defining the operating temperature, the intensity of radiation, the flow of product and the stir velocities required to achieve a desired product (particle size-distribution, volatile content, etc.).

There are various sensors (22, 23 and 24) located inside the vessel (10). They are submerged in the product and measure its temperature, which allows controlling the process during start up and during continuous stationary state. At the same time, they give a good indication of the flow's condition of the product along the length and width of the vessel (10).

The described process also applies when the production requires a controlled atmosphere. This controlled atmosphere can be in terms of pressure that are above or below atmospheric, or can be in terms of composition (N₂, CO₂, etc.). In both cases the granulating/drying machine must be sealed as described. The composition of the atmosphere that surrounds the product can be controlled adjusting the inert gas flow (25), see FIG. 3.

For continuous processes airtight or semi-airtight elements are necessary, which can allow the continuous or semi-continuous feeding and continuous extraction of the material. For this purpose 8-blades rotary valves (26) or systems of two valves with an intermediate chamber where one of the two valves (2) is always closed are employed.

The vacuum outtake and and/or outlet for volatile vapours are installed in the cover (28) for (29).

With regards to the airtight sealing of the IR source and the vessel, a cover (28) is used, which covers the perimeters of both these elements with an elastic seal. If the pressure inside is below atmospheric, there is no need for any additional attachments, as the vacuum effect itself will maintain the seal of the elements. If pressure above atmospheric is required, it is essential to attach pressure screws to ensure that the cover and vessel remain joined together. The shafts (11) have suitable tight sealing with gasket or packing glands.

In the case where solvent recovery is required, the equipment will be sealed and the generated vapours recovered via condensation by a cooling unit placed between the cover and the vacuum generator. In the case of operating without vacuum, the vapours will be condensed before being released into the atmosphere.

Operation in batch mode B:

The operation mode of this system differs from the previous continuous system A in that the quantities of different solid components to be granulated/dried are added to the vessel (10) at the beginning of the process. They are then mixed.

If drying is all that is required, one simply connects the IR source.

If granulation is required via the addition of a liquid spray, this is done at the beginning, gradually adding the required quantity.

Once the mass has been homogenously mixed and/or fully agglomerated into granules, the drying, if required, begin by connecting the IR source.

If the agglomeration occurs through a melted component, the IR can be applied during the mixing process.

Once the product had been granulated and/or dried, which you can judge by its physical aspect and by the temperature reached, it is discharged. The batch machine has a discharge door in its lower part so that it can be completely emptied.

Both the revolutions of the shafts (11) and the power emitted by the focusing screen (13) can be adjusted throughout the batch process to improve the homogeneity of the mix, to reduce the formation of dust clouds and to increase the efficiency and consistency of the process.

The shape and size of the batch machine can differ substantially from the images shown in FIGS. 1, 2, and 3. This is because the required capacity of the machine tends to be greater in order to produce large batches. In the batch process the quantity of product per unit of irradiated surface would be much higher than in a continuous process. The design of the stirring elements and placing of a door is such as to permit the complete emptying of the product once the batch process is completed.

The sealing elements for a batch machine are much simpler, as they only have to isolate the vessel and IR source from the surroundings.

Once this invention having been sufficiently described in accordance with the enclosed drawings, it will be understood that any detail modification can be introduced to the machine as appropriate, unless variations may alter the essence of the invention as summarized in the appended claims.

1- A procedure and machine for the agglomeration and/or drying of powdered materials through the use of infrared radiation, characterized in that the procedure comprises the following steps when working in continuous process:
continuous feeding of the component materials,
regulation of the weight flow of the product,
stirring via blades mounted upon shafts,
application of IR radiation,
eventual addition of liquid agglutinating material via pulverization,
extraction of volatile vapours, and
continuous discharge of the product;

2- The procedure and machine for the agglomeration and/or drying of powdered materials through the use of infrared radiation as claimed in claim 1, characterized in that the machine comprises a vessel (10) externally covered by an insulating material and which is fed of product (18) through a set of valves (2) or through a 8-blades rotary valve (26), and in whose interior at least two counter-stirring and extractable shafts (11) are positioned horizontally with attached blades (12), and provided with sensors (22, 23 and 24) for temperature control; in the upper part of the machine a focusing screen (13) is positioned horizontally, said focusing screen (13) externally covered with insulation material and thin disposable reflective sheets of metal and with a source of infrared radiation (14) in its interior and with a cover (28); the machine have an overflow discharge system with an adjustable height (9) at the opposite end of the vessel (10) to the product entry point of the vessel (10); all of the above is equipped with sealing means (2) and (26) to control the internal atmosphere and, when necessary an inert gas flow is added.

3- The procedure and machine for the agglomeration and/or drying of powdered materials through the use of infrared radiation as claimed in claim 2, characterized in that the rotational velocity of the shaft (15) is always slower than the rotational velocity of the shaft (16), the function of the shaft (15) being the renovation of the product at the upper surface of the mass by mixing it homogenously with the product located deeper down, and the function of the shaft (16) being the breaking up of those lumps that exceed a certain size.

4- The procedure and machine for the agglomeration and/or drying of powdered materials through the use of infrared radiation as claimed in claim 2, characterized in that the rotational velocities of the two shafts (15) and (16) is independently controllable.

5- The procedure and machine for the agglomeration and/or drying of powdered materials through the use of infrared radiation as claimed in claim 2, characterized in that the blades (12) have the possibility of varying the length, width, thickness and inclination (angle with respect to the shaft); this inclination of the blades (12) with respect to the aforementioned shafts (15) and (16) allows the adaptation of the products to be treated.

6- The procedure and machine for the agglomeration and/or drying of powdered materials through the use of infrared radiation as claimed in claim 2 and 5, characterized in that the outer points of the blades (12) act against the possible build up of product deposits on the external surface of the shafts (15) and (16).

7- The procedure and machine for the agglomeration and/or drying of powdered materials through the use of infrared radiation as claimed in claim 2, 5 and 6, characterized in that the inclination of the blades (12) with respect to the shafts (15) and (16) to which they are attached allows the control of the progress flow of the product inside the vessel.

8- The procedure and machine for the agglomeration and/or drying of powdered materials through the use of infrared radiation as claimed in claim 2, 5, 6 and 7, characterized in that the inclination of the blades (12) with respect to the shafts (15) and (16) to which they are attached allows the homogenisation degree of the product, in lateral and axial directions, and in composition and particle size.

9- The procedure and machine for the agglomeration and/or drying of powdered materials through the use of infrared radiation as claimed in claim 1, characterized in that in the addition of liquid agglutinating material via pulverization step the droplets size is comprised between 1 and 200 microns, and the quantity of this liquid represents 3-40% of the weight of the final dry/agglomerated product.

10- The procedure and machine for the agglomeration and/or drying of powdered materials through the use of infrared radiation as claimed in claim 2, characterized in that alternatively, in those cases of working with materials that form lumps, the height-adjustable overflow will be replaced with a screw system (19).

11- The procedure and machine for the agglomeration and/or drying of powdered materials through the use of infrared radiation as claimed in claim 2, characterized in that the focusing screen (13) have an adjustable height of 3 cm. minimum to 40 cm. maximum.

12- The procedure and machine for the agglomeration and/or drying of powdered materials through the use of infrared radiation as claimed in claim 2, characterized in that the internal surface of the machine's vessel (10) is highly reflective to IR radiation by employing such metals as aluminium, nickel, silver, zinc, and have a mirror finish.
